(19) United States
(12) Patent Application Publication
(10) Pub. No.: US 2014/0311303 A1
(43) Pub. Date: Oct. 23, 2014

(54) Screwdriver gripping tool

(71) Applicant: Ching-Chou Lin, Taichung (TW)

(72) Inventor: Ching-Chou Lin, Taichung (TW)

(73) Assignee: SHOU KING ENTERPRISE CO., LTD.

(21) Appl. No.: 13/986,296

(22) Filed: Apr. 19, 2013

(51) Int. Cl. B25B 23/10

(52) U.S. Cl. CPC B25B 23/101
USPC 81/452

(57) ABSTRACT

A screwdriver gripping tool is disclosed, comprising a sheath having an integrated unibody structure, and symmetrical elastic pinchers disposed at a tip of the sheath. The sheath is used for wrapping around a screwdriver handle; the elastic pinchers are used for holding on the screw head. The elastic pinchers also extendedly stretch to form two symmetrical, inwardly curving flanges that face each other, for use to capture a screw head so as to assist a driving motion of a screwdriver to set a screw into a work piece.

### BACKGROUND OF THE INVENTION

1. Fields of the Invention

The current invention is directed to a screwdriver gripping tool for use as fastener tool for assisting a screwdriver driving a screw head. More particularly, the current invention provides an accessory apparatus to a screwdriver for retaining a screw, the apparatus comprising a sheath having an integrated unibody structure, and symmetrical elastic pinchers disposed at a tip of the sheath.

2. Descriptions of Related Art

According to a United Kingdom patent GB 1507022, which was related to a screw holder system, it is already disclosed the screw holder system provides a function to grip firmly onto a screw and the handle of a screwdriver. Structurally the system comprises a sheath and pinchers, the sheath has cylindrical holding region throughout the sheath, pinchers on a tip of the sheath, which are arranged in such a way that two pinchers are established as an extension from a tip of the sheath. A construction of the invention involves the tips of the pinchers formed into protruding ends protruding inwardly and the their centers formed into concaved openings; another embodiment of the invention has the retaining portion of the pincher formed into conical ends extending inwardly; the sheath conformably disposes circumferentially on the wall of the docketing region three fan sheets spaced along the circumferential direction. The fan sheets can reach the position of the screwdriver handle and press axially against the handle; and in another embodiment, there is composed of collectors, the collectors are separated along the circumference, and provide the screwdriver with a significantly long retaining portion, such that the screwdriver can be prevented from titling when the screwdriver is being embedded for installation, in which the screwdriver handle is retained under the retaining effect in three axial directions.

The foregoing cited invention has been criticized for several disadvantages, including but not limited to, the following. Its docketing region is of a cylindrical shape, which can only provide for accommodation that is exclusively available for introduction of a special screwdriver handle. For example it can be accepting for a cross head screwdriver, but not a flat head screwdriver. The reason for this is because the driving portion of the flat head screwdriver is flat and has a width wider than the outer diameter of the screwdriver handle, and as a result of the driving portion cannot pass through the docketing region. This patent can, by or in itself, present a blockage limiting the types of usable screwdrivers.

Additionally, fan sheets and collectors all operate to retain the handles of the screwdrivers in three axial directions. Therefore the surrounding surface of the handles are not entirely secured in a pressed position, and such can still incur a shaky and tilting problem.

Also, with regards to the technical features in the cited prior art wherein it is cited that the tips of the pinchers are formed into protruding ends protruding inwardly and their centers are formed into concaved opening; or, in another embodiment of the cited prior invention, the retaining portion of the pincher is formed into conical ends extending inwardly, it is conceivable that the pinchers do not have sufficient elasticity to allow outward expansion. Consequently, after the pinchers are ensured to be fully gripping onto a screw head, after the screwdriver passes through the docketing region and rests onto the screw head to begin driving, next when the screw drills into a work piece and sinks into the work piece to finally reveal only the screw head, the protruding ends of the pinchers are still found to be securely enclosing the screw head. This situation would call for a requirement for the user to remove the pinchers by hands to detach from the screw head before the screw head becomes abutting against the work piece, and further that after the sheath is detached from the screwdriver, the user would be required to take extra effort to fasten the screw into the work piece with a screwdriver. This is heavily complained for operational inconvenience.

### SUMMARY OF THE INVENTION

An objective of the present invention is to provide a gripping tool for holding on a screwdriver handle. The gripping tool can enclose a handle firmly and avert tilting or vibration, can pinch and detach easily a screw head, and can be applied for use with various kinds of screwdrivers.

According to the present invention, the screwdriver gripping tool comprises a sheath having an integrated unibody structure, and symmetrical elastic pinchers disposed at a tip of the sheath. The sheath is used for housing a screwdriver handle, the elastic pinchers are used for holding a screw head, and ends of the elastic pinchers are formed into two symmetrical, inwardly curving flanges that face each other.

The shape of the sheath is presented to be long, flat and tubular, it has an axially extending docketing region throughout the sheath, and has on one side of the sheath a longitudinally reaching securing mechanism. There are thin slits on two sides of the securing mechanism. The securing mechanism has a protruding gripping rib at the inside of the docketing region, for use in abutting against a screwdriver handle, and making the sheath less susceptible to tilting or vibration; the top view of the foregoing docketing region shows a long and flat space configuration, which is used for facilitating settling onto screwdriver handle. The docketing region has a first docketing region and a second docketing region, in which the second docketing region is included in the center of the first docketing region, and the length of the first docketing region is longer than that of the second docketing region, but the width of the second docketing region is larger than the width of the first docketing region; and elastic pinchers are two symmetrical and inwardly curving flanges formed as a result of the extension of a tip of the sheath coming from the sheath's integrated unibody structure, wherein the pinchers are used for enclosing a screw head.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is an isometric view of the present invention.

FIG. 2 is a top view of the present invention.

FIG. 3 is a top perspective view of the present invention.

FIG. 4 is a top perspective view of an example 1 of the present invention that is inserted with a screwdriver.

FIG. 5 is a top perspective view of an example 2 of the present invention that is inserted with a screwdriver.

FIG. 6 is a view showing an operational example 1 using the present invention that is inserted with a screwdriver.

FIG. 7 is a view showing an operational example 2 using the present invention that is inserted with a screwdriver.

FIG. 8 is an isometric view of another example of the present invention.

FIG. 9 shows an isometric view of another example of the elastic pinchers of the present invention.

FIG. 10 shows a frontal view of another example of the plastic pinches of the present invention.

### DETAILED DESCRIPTION OF THE PREFERRED EMBODIMENT

In order to fully understand the present invention, operational advantages of the present invention, and objects achieved by the implementation of the present invention, the accompanying drawings illustrating preferred embodiments of the present invention and the contents described in the accompanying drawings need to be referred to. Hereinafter, preferred embodiments of the present invention will be described in detail with reference to the accompanying drawings, such that one skilled in the art will be able to practice the present invention using the application as a guide. The application is not intended to be restrictive of the technical scope of the present invention.

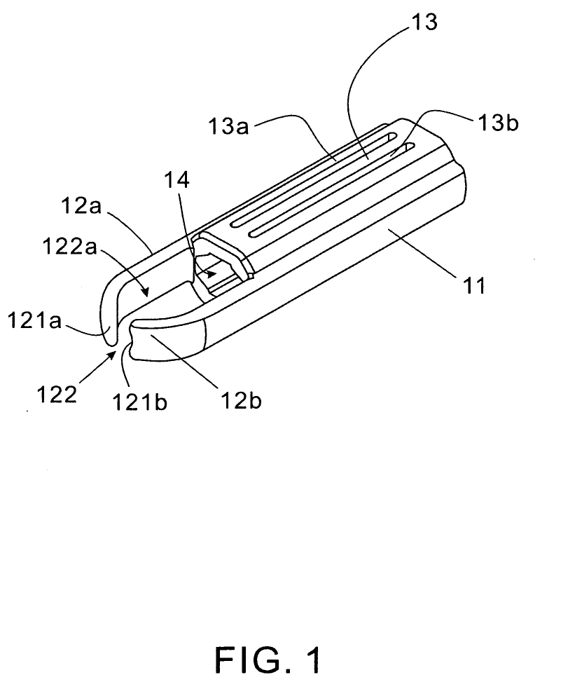

First, in reference to FIG. 1, a screwdriver gripping tool is shown, The screwdriver gripping tool comprises a sheath 11 made from a plastic material and formed into an integrated unibody structure, and a pair of elastic pinchers 12a, 12b. The sheath 11 is used in enclosing a screwdriver handle 15, the elastic pinchers 12a, 12b are used for holding on a screw head 16a of a screw 16 and ends of the elastic pinchers 12a, 12b are two symmetrical inwardly curving flanges 121a, 121b. Because the elastic pinchers are made of elastic plastic materials, the elastic pinchers 12a, 12b are capable of elastic deformation, which can provide a means for holding a screw head 16a, and can also expand outwardly to release the screw head 16a when the pinchers are subject to external forces.

The sheath 11 has a long tubular shape, which has an axially extending docketing region 14 throughout the sheath 11, has on one side of the sheath 11 a longitudinally reaching securing mechanism 13, and has inside the sheath 11 a protruding securing mechanism 13, the securing mechanism 13 has thin slits 13a, 13b on two sides of the securing mechanism 13, by way of the disposition of the thin slits 13a, 13b, the securing mechanism 13 is elastic, such that the docketing region 14 can expand and suppress when the screwdriver handle 15 is inserted into the docketing region 14, so the sheath 11 can grip firmly the screwdriver handle 15 and prevent vibration. The securing mechanism 13 is a narrowly long and has longitudinal length that can press against a side perimeter of the screwdriver handle 15.

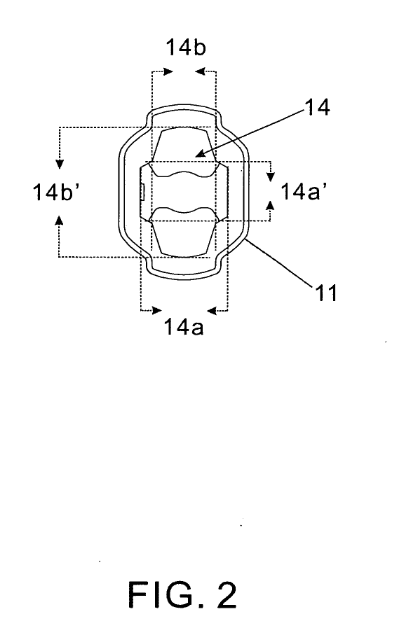

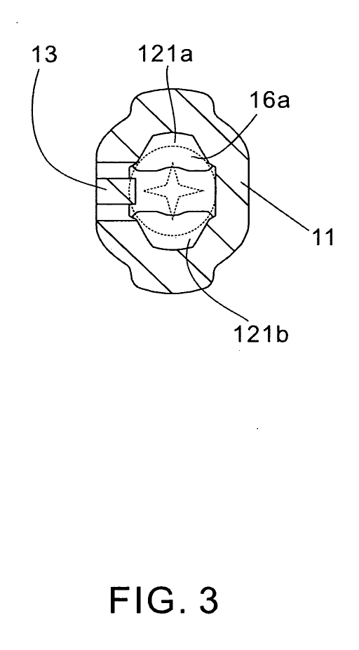

Reference is now drawn to incorporation of FIGS. 2, 3, 4, 5, as well as the abovementioned top view of the docketing region appearing as a long spatial configuration, which is used for enclosing the screwdriver handle 15, which comprises a first docketing region 14a and a second docketing region 14b, wherein the second docketing region 14b is included in the center of the first docketing region 14a, and a length of the first docketing region 14a is longer than a length of the second docketing region 14b, but a width of the second docketing region 14b is larger than a width of the first docketing region 14a′; and the elastic pinchers 12a, 12b are formed in a unibody structure from an extension of the sheath, and an end of the sheath 11 forms inwardly curving flanges 121a, 121b, which are adapted for use for enclosing a screw head 16a. Each of the elastic pinchers 12a, 12b has a side that together defines a free spatial opening by a clamp opening 122a. The clamp opening 122a is configured to expand the elastic pinchers 12a, 12b so as to allow introduction of the screw head 16a from any side of the two sides of the elastic pinchers 12a, 12b. The flanges 121a, 121b have a flat, curving shape, and are formed into a simple passage 122 such that the passage 122 is applicable for allowing introduction of a screw 16.

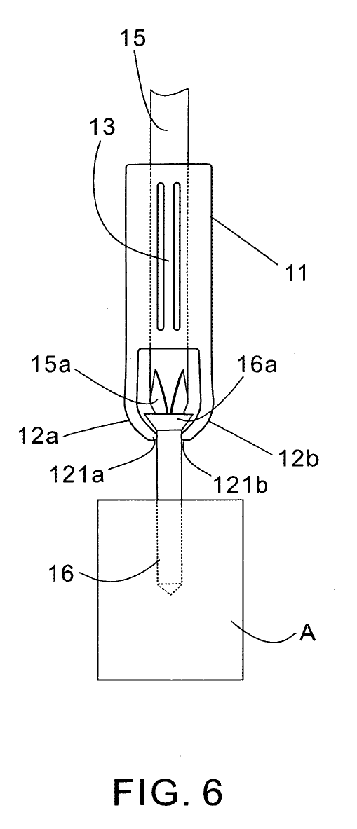

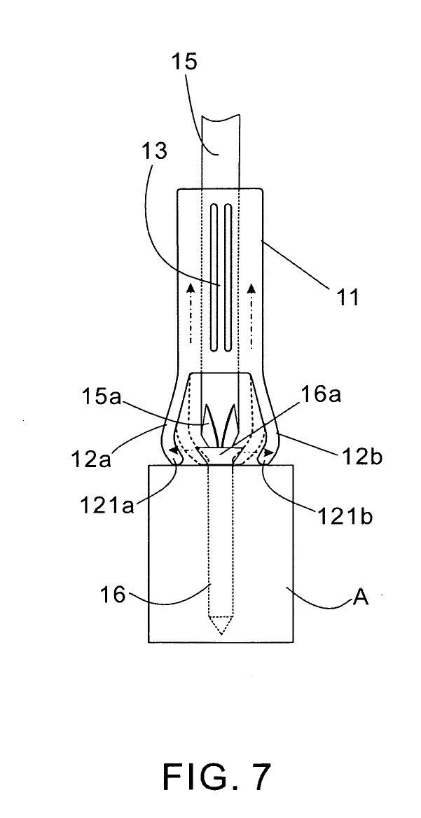

Next, FIG. 6 shows an example for actual use of the gripping tool of the present invention. The screwdriver handle 15 is inserted into the sheath 11 of the gripping tool. The driving blade 15a protrudes and stretches to elastic pinchers 12a, 12b, screw head 16a is enclosed from the clamp opening 122a, where the flanges 121a, 121b of the elastic pinchers 12a, 12b capture the screw stem below the screw head 16a. When the screwdriver drives the screw 16 into the work piece A, when the screw 16 gradually sinks into work piece A until there is left with the screw head 16a, which is shown in FIG. 7, the flanges 121a, 121b of the elastic pinchers 12a, 12b abut against the surface of the work piece A, and because the screwdriver handle 15 gradually applies pressure downward to make the elastic pinchers 12a, 12b to change shape and expand outwardly, the sheath 11 would also gradually move upwardly in the longitudinal direction toward the screwdriver handle 15. Finally, the flanges 121a, 121b detach from the screw head 16a, and the screw head 16a is continually worked upon to sink into the work piece A by the driving motion of the screwdriver handle 15, until the screw stem is entirely sunk into the interior of the work piece A.

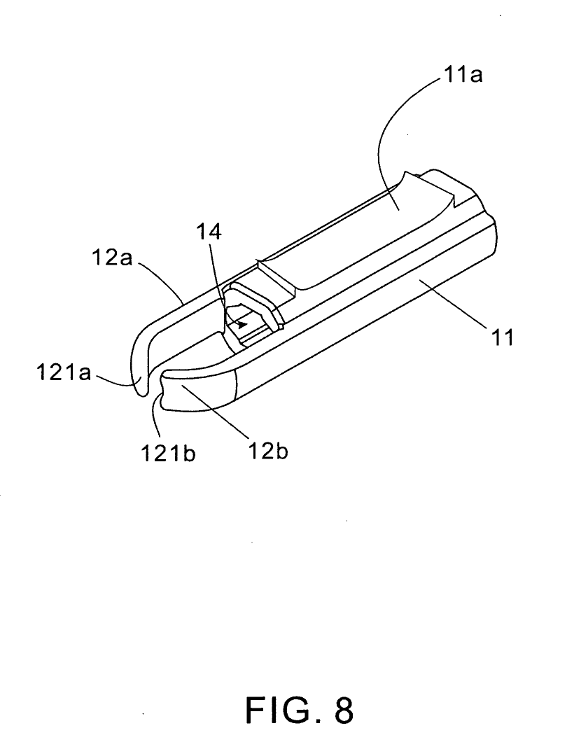

As shown in FIG. 8 for another embodiment of the present invention, there is disposed an abutting portion 11a on a surface opposite to the securing mechanism 13 on the sheath 11. The foregoing abutting portion 11a is a protruding block formed in a unibody structure sharing with an upper surface of the sheath 11. By way of this setup, the user can the abutting portion 11a to operate the gripping tool to remove the screwdriver handle 15.

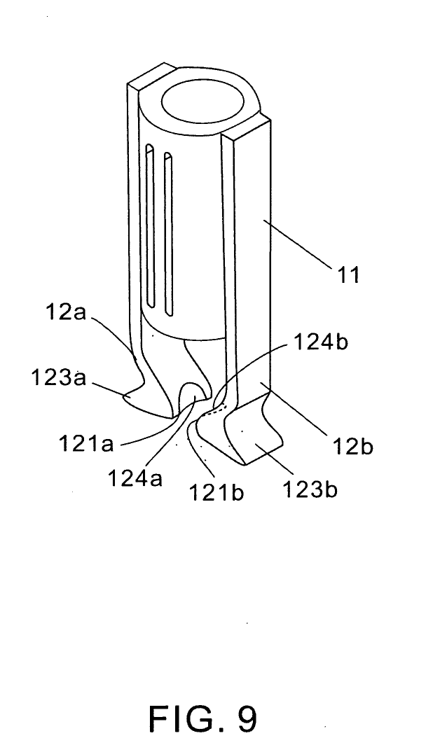

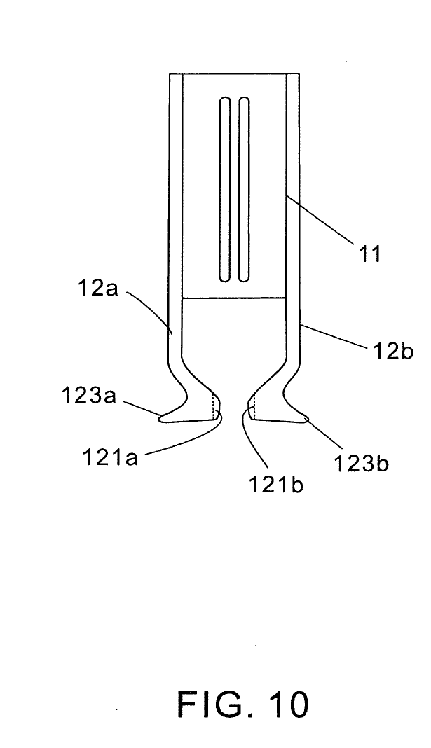

In reference to FIGS. 9 and 10, elastic pinchers 12a, 12b of another embodiment of the present invention are shown. These are used when the work piece A does not have a planar platform, for example, when the work piece A may have a default trough, or it may have an uneven trough. For these situations, ends of the elastic pinchers 12a, 12b of the preset invention are disposed with outwardly extending protruding ribs 123a, 123b. The protruding ribs 123a, 123b are disposed at a reverse position respective to each other, and a bottom end of the protruding rib is an angled surface and has flanges 121a, 121b. The inner ends of the flanges 121a, 121b are disposed with depressed tips 124a, 124b. The depressed tips 124a, 124b have a depressed arc shape, such that the depressed pattern is adapted for use for a position limiting purpose subject to the flanges 121a, 121b are holding the screw head 16a in place. In other words, in compliance with the circular feature of the screw head 16a, depressed tips 124a, 124b having a depressed arc shape are selected so that the screw head 16a can be restricted to its position subject to their circular diameter, such that the flanges 121a, 121b can easily hold on the screw head 16a and make it less easy to fall off. Additionally, the protruding ribs 123a, 123b operate to abut against the larger area of the upper surface of the work piece A. When the screwdriver handle 15 gradually applies pressure downwardly to let the elastic pinchers 12a, 12b to outwardly expand to open, the sheath 11 also gradually provides a window for the screwdriver handle 15 to move upwardly in a longitudinal direction. At last, the flanges 121a, 121b will detach the screw head 16a, the screw head 16a will continually sinks into the work piece A as a result of the screwdriver handle's driving motion, up until a point when the screw stem of the screw is entirely buried in the work piece A.

In view of the above disclosure, a skilled person in the relevant art would recognize that the present invention has the following advantages:

1. The clamp opening 122a is a spatial opening defined by the two sides each disposed by each of the elastic pinchers 12a, 12b. This can make the screw head 16a highly susceptible to coverage between elastic pinchers 12a, 12b. Flanges 121a, 121b are flat and inwardly curving, and can help in holding on the screw head 16a, and give the elastic pinchers 12a, 12b with an abutting ability in outward expansion, thereby achieving a goal of helping elastic pinchers 12a, 12b to expand outwardly and release the screw head 16a.

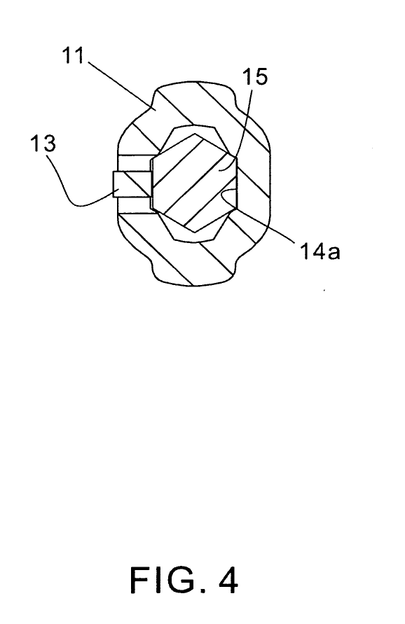

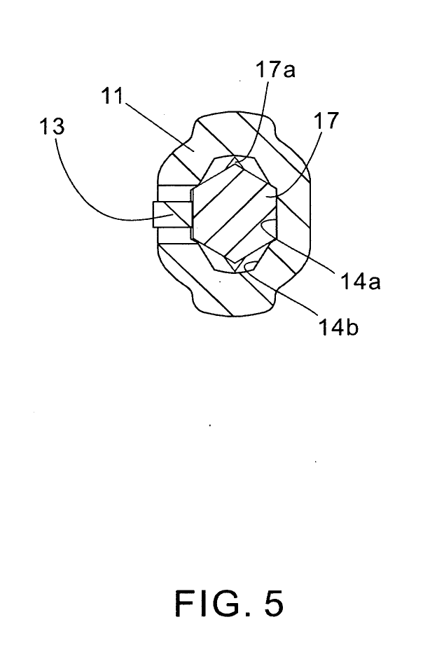

2. The docketing region 14 presents a long spatial configuration seen from a top view, which comprises a first docketing region 14a and a second docketing region 14b, wherein the second docketing region 14b is included in the center of the first docketing region 14a, and a length of the first docketing region 14a is longer than a length of the second docketing region 14b, but a width of the second docketing region 14b is larger than a width of the first docketing region 14a′ such that a variation of screwdriver handles 15 can be applied onto, as shown in FIG. 4 which shows a situation where a cross head screwdriver handle is coupled into a docketing region 14. The drawing shows that the two sides of the screwdriver handle 15 abuts against the second docketing region 14b, and the securing mechanism on the protruding part on the inside of a docketing region 14 is set up to abut against screwdriver handle 15 such that the handle 15 is not prone to vibration. FIG. 5 further shows a situation where a flat head screwdriver handle is coupled into a docketing region 14. The width of the screwdriver driving blade 17a is substantially longer than the second docketing region 14b, but matches the length of the first docketing region 14a. Therefore by way of demonstration the gripping tool can be used for both flat head screwdriver and cross head screwdriver.

3. The sheath 11 of the gripping tool can work to lasso the screwdriver handle 15, and the securing mechanism 13 protruding from the inside of the docketing region can abut against the outer wall of the handle 15 such that the screwdriver handle 15 does not vibrate, but can freely move longitudinally.

4. The securing mechanism 13 is disposed on its side an abutting portion 11a, which can help release the sheath away from the screwdriver handle 15. The abutting portion 11a can have a knurled or a sawtoothed protruding rib structure, or have a roughened structure for the purpose of increasing coefficient of friction of the abutting portion 11a.

The invention has been described herein by illustration of a preferred exemplary embodiment. The specification and drawings are, accordingly, to be regarded in an illustrative rather than a restrictive sense. Further, it will be apparent to those skilled in the art that other embodiments having equivalent modification and change are possible within the scope of the invention.

What is claimed is:

1. A screwdriver gripping tool, comprising a sheath and a pair of elastic pinchers, wherein the sheath is made from a plastic material and formed into an integrated unibody structure, wherein a tip of the sheath extends into elastic pinchers and the elastic pinchers are two symmetrical inwardly curving flanges, the sheath is adapted for use for enclosing a screwdriver handle, the elastic pinchers are adapted for use for holding on a screw head; the sheath has a long tubular shape, which has an axially extending docketing region throughout the sheath, has on one side of the sheath a longitudinally reaching securing mechanism, and has inside the sheath a protruding securing mechanism; and the docketing region presents a long spatial configuration seen from a top view, which comprises a first docketing region and a second docketing region, wherein the second docketing region is included in the center of the first docketing region, and a length of the first docketing region is longer than a length of the second docketing region, but a width of the second docketing region is larger than a width of the first docketing region such that a variation of screwdrivers can be applied onto.

2. The screwdriver gripping tool according to claim 1, wherein the securing mechanism has thin slits on two sides of the securing mechanism adapted for use in making the securing mechanism elastic, such that the docketing region can expand and suppress when the screwdriver handle is inserted into the docketing region, so the sheath can grip firmly the screwdriver handle and prevent vibration.

3. The screwdriver gripping tool according to claim 1, wherein the elastic pinchers are formed in a unibody structure from an extension of the sheath, and an end of the sheath forms inwardly curving flanges, which are adapted for use for enclosing a screw head.

4. The screwdriver gripping tool according to claim 1, wherein the flanges are flat and two curving entities facing each other.

5. The screwdriver gripping tool according to claim 1, wherein the securing mechanism has an abutting portion on a side surface of the securing mechanism, which is adapted for use for releasing the screwdriver handle, the securing mechanism has a knurled or a sawtoothed protruding rib, or the abutting portion is roughened, which is adapted for use for increasing coefficient of friction on the abutting portion.

6. A screwdriver gripping tool, comprising a sheath and a pair of elastic pinchers, which is made from a plastic material and formed into an integrated unibody structure, wherein a tip of the sheath extends into elastic pinchers and the elastic pinchers are two symmetrical inwardly curving flanges, wherein the sheath is adapted for use for enclosing a screwdriver handle, the elastic pinchers are adapted for use for holding on a screw head, wherein the flanges are flat and inwardly curving and two symmetrical ends of the flanges are formed into a simple passage such that the passage is applicable for allowing introduction of a screw, wherein the elastic pinchers each has a free clamp, which is configured to expand the elastic pinchers so as to allow introduction of the screw head from any side of the two sides of the elastic pinchers.

7. The screwdriver gripping tool according to claim 6, wherein the sheath has a long and tubular shape, and has an axially extending docketing region throughout the sheath, and has on one side of the sheath a longitudinally reaching securing mechanism, wherein the securing mechanism is narrowly long and has a longitudinal length that can press against a side perimeter of the screwdriver handle.

8. The screwdriver gripping tool according to claim 7, wherein the securing mechanism is a protruding block on a surface of the docketing region, so as to hold firmly the screwdriver handle and prevent vibration.

9. The screwdriver gripping tool according to claim 6, wherein a top view of the docketing region shows a long space configuration, wherein the docketing region has a first docketing region and a second docketing region, in which the second docketing region is included in the center of the first docketing region, and the length of the first docketing region is longer than that of the second docketing region, but the width of the second docketing region is larger than the width of the first docketing region, such that a variation of screwdriver handles can be applied onto by the sheath.

10. A screwdriver gripping tool, comprising a sheath and a pair of elastic pinchers, which is made from a plastic material and formed into an integrated unibody structure, wherein a tip of the sheath extends into elastic pinchers and the elastic pinchers are two symmetrical inwardly curving flanges, the sheath is adapted for use for enclosing a screwdriver handle, the elastic pinchers are adapted for use for holding on a screw head; the sheath has a long tubular shape, which has an axially extending docketing region throughout the sheath, has on one side of the sheath a longitudinally reaching securing mechanism, and has inside the sheath a protruding securing mechanism; the securing mechanism has thin slits on two sides of the securing mechanism adapted for use in making the securing mechanism elastic, such that the docketing region can expand and suppress when the screwdriver handle is inserted into the docketing region, so the sheath can grip firmly the screwdriver handle and prevent vibration.

11. The screwdriver gripping tool according to claim 10, further comprising outwardly extending protruding ribs at distal ends of the elastic pinchers, wherein each of the protruding ribs is disposed at a reverse position respective to each other, and a bottom end of the protruding rib is an angled surface and extends inwardly to be disposed with flanges.

12. The screwdriver gripping tool according to claim 10, wherein inward surfaces of the flanges are disposed with depressed tips and the depressed tips have a depressed arc shape, such that the depressed tips are adapted for use for a position limiting purpose subject to the flanges holding the screw head in place.
